(19) United States
(12) Patent Application Publication
(10) Pub. No.: US 2002/0184352 A1
(43) Pub. Date: Dec. 5, 2002

(54) Firmware common operations and reset environment

(76) Inventors: Sunit Jain, Sunnyvale, CA (US); Mehrdad Mojgani, Cupertino, CA (US); Ashish Munjal, Sunnyvale, CA (US); Yu Kong, Santa Clara, CA (US); Mir J. Hyder, Sunnyvale, CA (US); Chun-hui Huang, Cupertino, CA (US); Fu-Yuan Lin, Santa Clara, CA (US)

Correspondence Address: Michael J. Mallie, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/860,948

(22) Filed: May 17, 2001

(51) Int. Cl. G06F 15/16; G06F 15/173

(52) U.S. Cl. 709/223; 709/203

(57) ABSTRACT

A system having a common operations and reset environment and method for using the same are described. In one embodiment, the system comprises one or more hardware resources, client programs stored in memory, and an operations and reset environment shared by the clients. The operations and reset environment implement hardware specific functions to make available the one or more hardware resources to the clients using a common programming interface.

### FIELD OF THE INVENTION

The present invention relates to the field of computer systems; more particularly, the present invention relates to an operations and reset environment shared by multiple clients.

### BACKGROUND OF THE INVENTION

Every platform needs initialization of the hardware resources prior to booting the next level of functionality. This next level of functionality may be an operating system (OS) or application program, both of which are referred to herein as clients. System firmware is responsible for setting up a proper environment for this purpose. Sun SPARC platforms use OpenBoot firmware (OBP) to boot Solaris, Chorus and JavaOS operating systems. Once these OBP clients take over the system, in most cases, they replace drivers used to access the hardware resources with their own drivers. For VxWorks, the Board Support Package (BSP) handles the cold boot to load its client (RTOS). FIG. 1 illustrates these two platforms.

Referring to FIG. 1, in both platforms, the basic system initialization (A) is executed from the PROM and performs the following functions: 1) basic initialization for resources such as the processor, caches, super I/O, TTY, memory, etc.; 2) loading the client (e.g., Forth Virtual Machine (FVM)/VxWorks) into memory and decompressing it; and 3) transferring control to the downloaded code. Thereafter, the FVM (in the case of OBP) or the BSP run from memory (e.g., random access memory))(B).

This firmware model makes it difficult and expensive to port an RTOS or embedded application to the platform. This multiplies the porting effort by the number of operating systems and makes platforms expensive in the embedded world and risk in time to market because of expensive development costs associated with OBP.

For any piece of software to run on a SPARC machine (OBP, VxWorks, Chorus etc.), the hardware needs to be initialized first. The basic system initialization essentially remains the same for these softwares. In the current approach, each of these softwares perform hardware initialization, and thus, hardware initialization code has been duplicated for them (including development and debugging time as well).

The OBP includes two parts, the first part includes two binaries that are compiled separately and glued together. These binaries perform the hardware initialization, such as setting up CPU, caches, etc. Each of these binaries includes its own driver for the same purpose. However, both may be written in different languages, Forth or Forth Assembly, which are not user friendly. Therefore, if a change in the platform is desired, binaries in these two systems may have to be changed, which is not easy for the languages they are written. The OBP also includes another portion that is referred to as POST, which performs diagnostics on the hardware. POST is written in C language and also includes its own driver. Therefore, there are also multiple copies of some initialization routines and basic drivers in OBP and POST. Each of the multiple copies which requires maintenance, PROM space and duplicated effort.

### SUMMARY OF THE INVENTION

A system having a common operations and reset environment and method for using the same are described. In one embodiment, the system comprises one or more hardware resources, client programs stored in memory, and an operations and reset environment shared by the clients. The operations and reset environment implement hardware specific functions to make available the one or more hardware resources to the clients using a common programming interface.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates a prior art approach to system initialization.

FIG. 2 illustrates one embodiment of a software hierarchy for system initialization.

FIGS. 3A through 5B illustrate hardware operations that may be accessed by clients using a soft trap mechanism.

FIGS. 6A and B illustrate a buffer used in an exemplary trap.

FIG. 7 illustrates one embodiment of the services available to manipulate trap entries.

FIG. 8 is a block diagram of an exemplary computer system

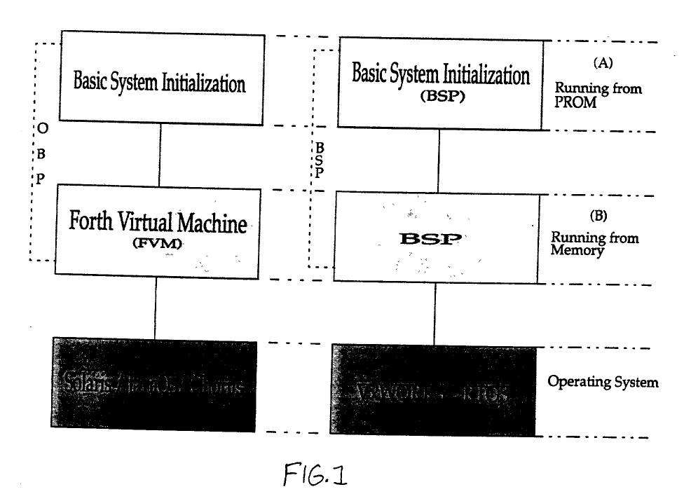

### DETAILED DESCRIPTION OF THE PRESENT INVENTION

A firmware CORE (Common Operations and Reset Environment) is described. The firmware CORE provides a common programming interface to client programs (e.g., operating systems, application programs) to access a set of shared hardware resources, including the initialization of these hardware resources. In this manner, the firmware CORE may unify the system initialization and I/O operations for higher level clients (e.g., OBP, VxWorks, Chorus in platforms of Sun Microsystems, Inc. of Mountain View, Calif.) into one location and reduce the porting effort for a new operating system (OS) or application as a client of the firmware CORE.

The firmware code includes programming code. The unified initialization code of the CORE may be written in a popular language (‘C’) so that it may be shared by multiple clients (higher level piece of software).

In one embodiment, the CORE comprises a common hardware initialization code and driver set, similar to a personal computer BIOS model, with a well-defined interface for use by higher level client programs. This simplifies and unifies the porting effort. That is, the CORE may initialize hardware. Initialization may include, for example, but not limited to, enabling or disabling some hardware, flushing a memory, testing hardware, obtaining addresses, determining the number of devices present, loading files, etc. Thus, the CORE unifies the hardware initialization function and co-exists with client programs such as, for example, operating systems and application programs.

Furthermore, instead of each of these clients carrying their own device drivers to communicate with hardware, the CORE defines a set of trap services that higher level software use to communicate with the hardware. That is, in one embodiment, the CORE also implements hardware specific functions and make them available to clients via well-defined soft trap services so that clients do not have to implement those functions themselves. Thus, duplicate device drivers can be removed from the higher level software and localized in the CORE.

Therefore, the present invention avoids having duplicate copies of initialization and basic drivers in systems by having many, if not most or all, system dependent configuration/initialization/drivers in one reset environment to be shared by all clients that need them.

In the following description, numerous details are set forth to provide a thorough understanding of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Introduction

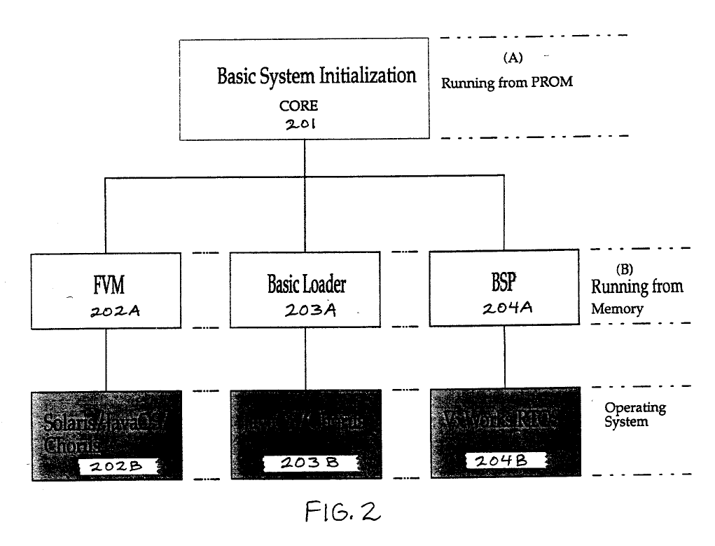

Common operations and reset environment (CORE) firmware provides a common programming interface to all operating systems or applications that are targeted to run on a platform to facilitate system initialization and access to hardware resources by those clients. FIG. 2 illustrates one embodiment in which the CORE firmware is included in a platform based on the SPARC-V9 architecture (although the details of a SPARC-V9 architecture are not necessary to the understanding of the present invention). Referring to FIG. 2, since the basic functionality of the basic system initialization (shown as A) is the same in both OBP and BSP, the firmware CORE 201 supports both cases. In one embodiment, firmware CORE 201 runs from PROM and loads clients such as FVM 202A Solaris/JavaOS/Chorus 202B and BSP 204A VxWorks RTOS 204B. Using this common firmware approach, a basic loader 203A can be developed to load JavaOS and Chorus (203B). This reduces, and potentially minimizes, firmware effort needed to support all these clients.

In one embodiment, firmware CORE 201 also provides hardware dependent services needed to initialize the system for its clients, such as display to TTY, read/write floppy, etc.

To gain access to the operations available through the firmware CORE 201, processors in the system include a common software trap structure that is useful for the common programming interface of CORE firmware 201. In this way, clients may not need to carry another copy of the drivers and may use those services provided by firmware CORE 201.

Software Trap Model and Definition

To use the firmware CORE to gain access to the common operations (e.g., hardware operations), a software trap model is used. The firmware CORE sets some software trap handlers to provide hardware dependent services to higher level software. In one embodiment, the higher level software may also install or modify the CORE's trap handlers using services provided by the CORE.

In one embodiment, the input and output parameters to the trap service are passed in a buffer, and the buffer has the following format:

typedef struct parameters {

unsigned long long par0;
unsigned long long par1;
unsigned long long par2;
unsigned long long par3;
unsigned long long par4;
unsigned long long par5;

} parameters;

In one embodiment, the “long long” represents 8 bytes. Therefore, in this embodiment, the buffer includes 48 bytes (6×8 bytes).

The trap function is specified according to the following:

Parameters TrapXXX (parameters pars)

In one embodiment, the same buffer is used for input and output parameters, and the parameter named parameter.par0 has a fixed usage:

parameter.par0 (input parameter)=Sub-function#

parameter.par0 (output parameter)=Status (OK=0, ErrorID<>0)

Before passing control to a client, the CORE creates a list of all trap services and passes its address to the client in a global register. This is in addition to the system trap table. Clients may either execute the soft trap via an instruction or use the trap table to make use of the services provided by the CORE. In one embodiment, the table has the following format:

Struct service {

Unsigned int services_number;
Parameters * (*trap_service) (parameters *par);

} services [ ] = {

{ 100, Trapname0 },
{ 101, Trapname1 },
.
.
.

};

In one embodiment, the trap table includes a routine of a number of instructions (e.g., 8 instructions) for each trap and during the execution of these instructions a jump is performed to another instruction block to implement these particular trap functions.

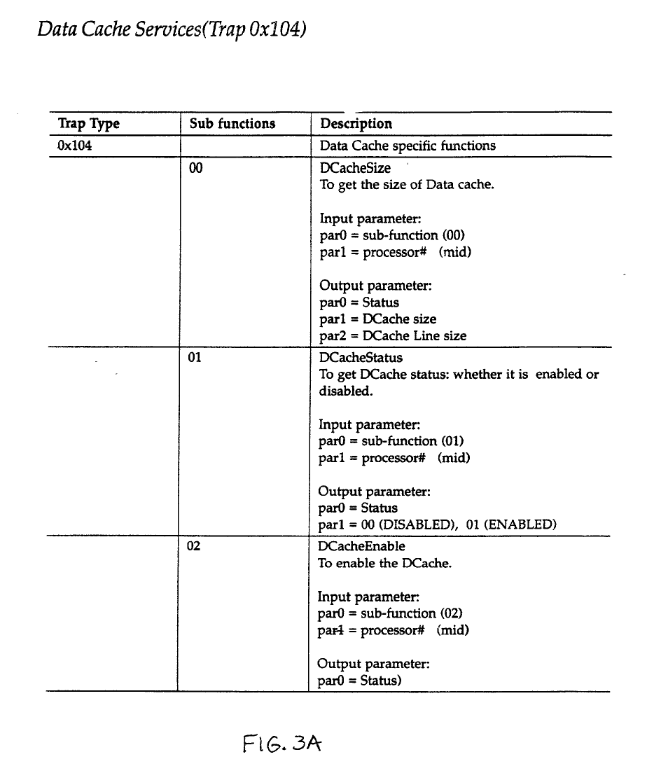

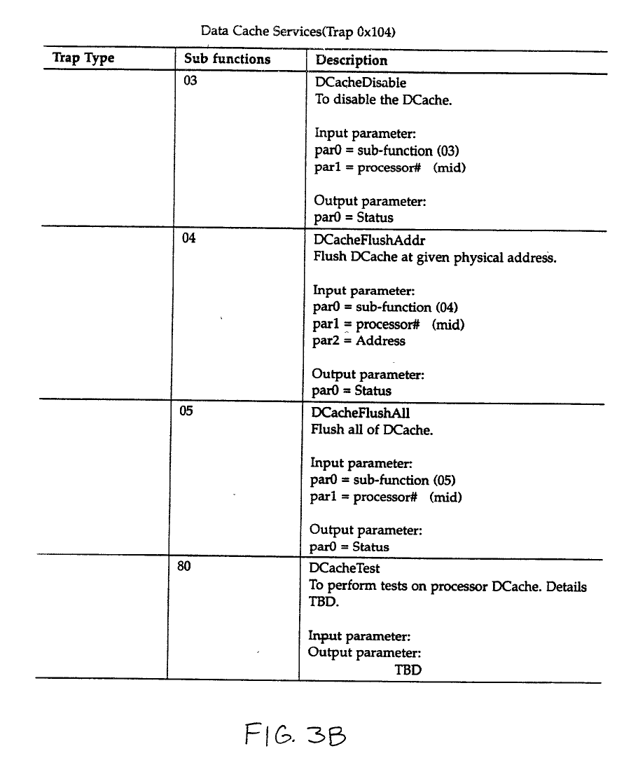

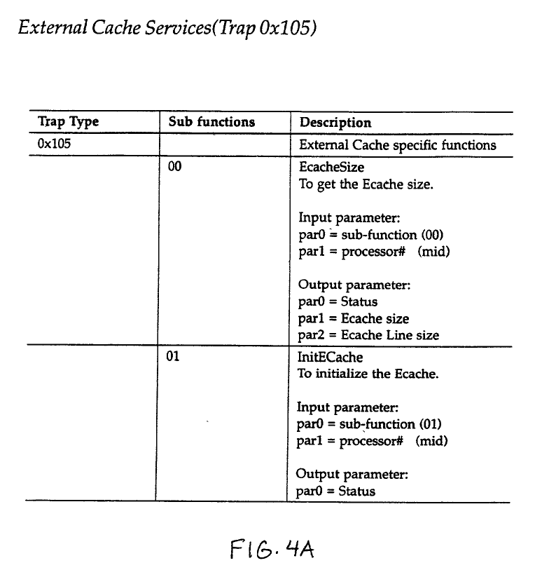

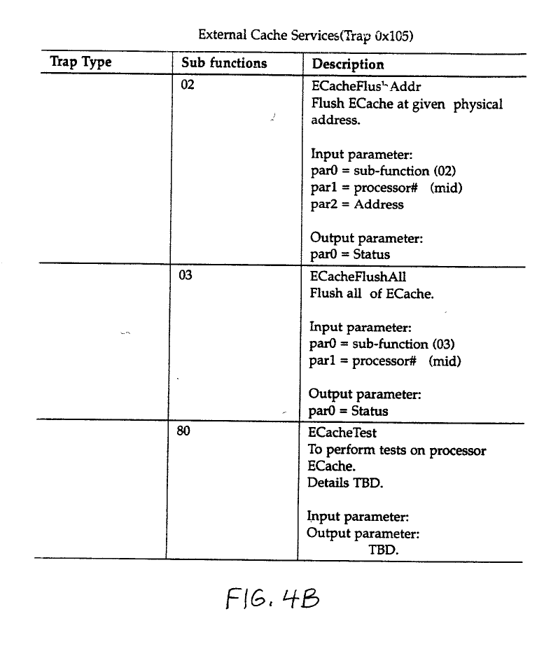

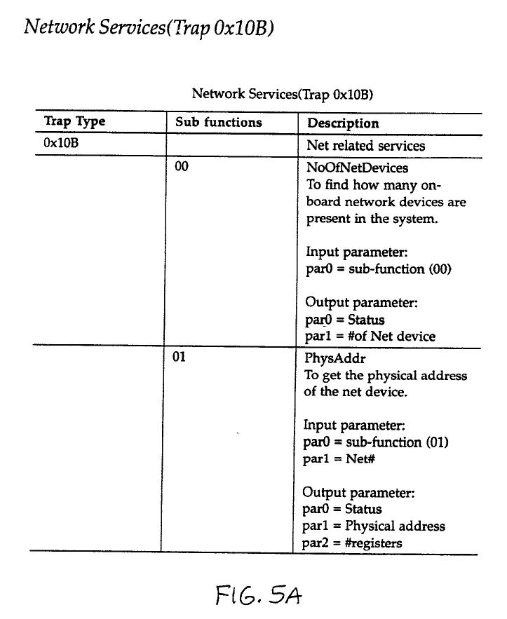

FIGS. 3 through 5 illustrate hardware operations that may be accessed by clients using the soft trap mechanism. Referring to FIGS. 3 and 5, all of the operations include a number of sub functions related to the type of trap specified, as well as the input and Output parameters related to the subfunction.

For example, if a client desires to determine the size of the external cache, the client specifies the following:

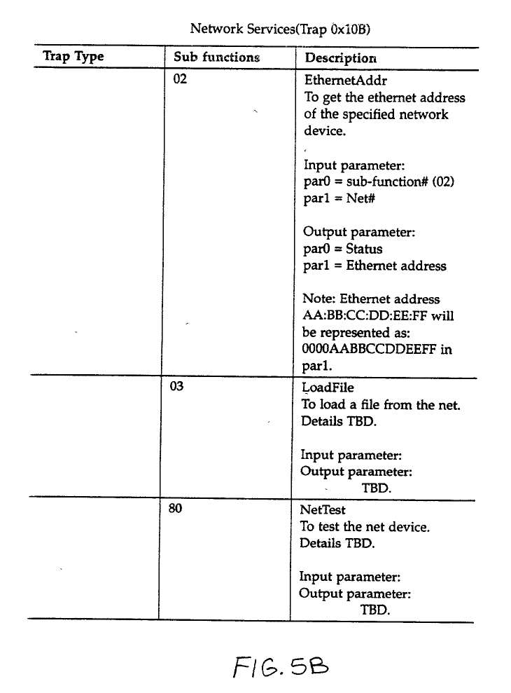

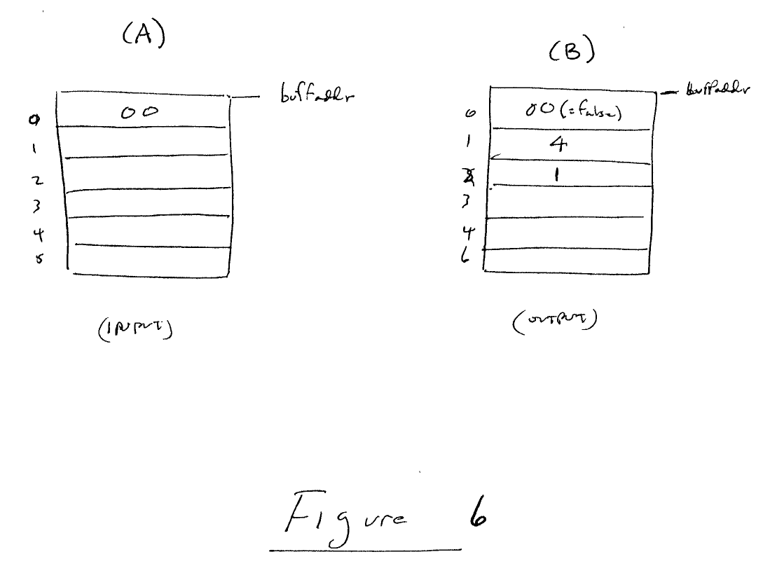

trap105, buffaddr

where the buffaddr is an input address of the buffer and is supplied with the trap. The buffer is located in memory ahead of time at an address, which is buffaddr in this example. Prior to issuing the trap command, the client stores a subfunction in the entries of the buffer. In this example, as shown in FIG. 6A, the subfunction associated with obtaining the external cache size is 00. Therefore, 00 is put in the first entry of the buffer in FIG. 6A. Thus, the buffer stores the parameters necessary to specify the operation associated with the particular trap to the CORE.

In response to the trap command, the CORE accesses the trap table looking for trap 105. Stored at the memory location allocated to trap 105 is a routine to determine the cache size. The CORE executes the routine. During execution, the buffer specified by buffaddr and the subfunction specified therein (00) determine that the client desires to get the external cache size. The CORE then uses the same buffer and responds by putting the external cache size into a buffer entry. In the case of the external cache, the output parameters to respond to a request for the external cache size uses three buffer entries, such as shown in FIG. 6B. The first line of the buffer indicates that status of the data in the buffer, which will be true or false. In one embodiment, a false indication indicates that there is good data in the buffer to follow. The second entry of the buffer indicates the cache size and the third output parameter is the external cache line size. After storing the information in the buffer, the CORE signals the client that the operation has been completed and the client accesses the buffer to obtain the results.

An Exemplary Embodiment

In one embodiment, the CORE initially runs from PROM until it is able to access memory. Once it initializes the memory, it copies a part of itself to memory for faster execution and also sets up the trap table in memory.

In one embodiment, the CORE is responsible for initializing the following devices: processors; internal and external caches, memory management unit (MMU); TTY; UPA-PCI and PCI-PCI bridges; SuperIO (e.g., keyboard/mouse etc.); memory; I/O drives (e.g., Net, Floppy, NVRAM, Flash, etc.).

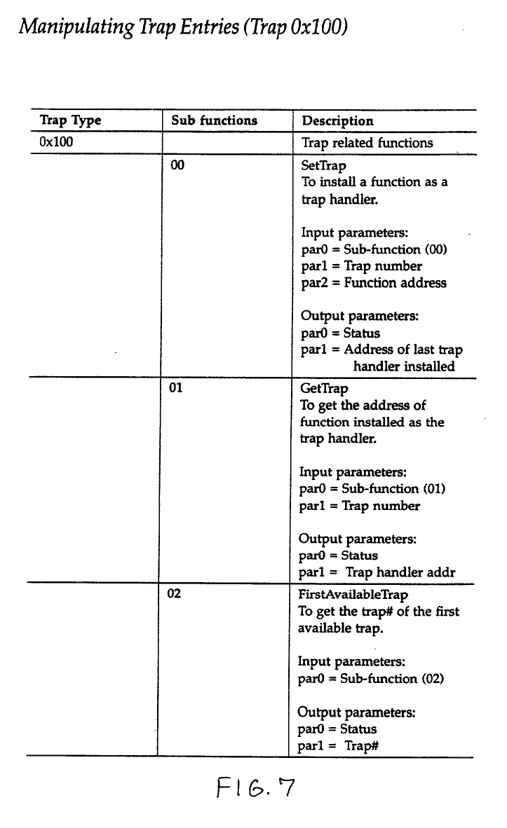

The CORE is also responsible for setting up the trap table. In one embodiment, after the memory is accessible, the base trap table is copied to main memory. Services to manipulate the CORE trap table are provided, including SetTrap( ) and GetTrap( ) to install/get a Soft trap. FIG. 7 illustrates one embodiment of the services available to manipulate trap entries. These services are available as Soft traps. This allows clients to add new (or replace the default) trap handlers in the trap table.

The CORE may also test on-board hardware resources (e.g., caches, MMUs, etc.) with built-in diagnostics and identify client firmware (if necessary for the CORE to do some legacy functions for a client).

In one embodiment, the flow of execution is as follows: setup the processor(s); setup system in quiet state (errors and interrupts disabled); initialize state variables in NVRAM; primary initialization of PCI and the external bus; initialize Super IO and TTY; setup memory timnings; verify NVRAM magic number; set defaults if bad magic number; probe and initalize keyboard (INPUT−DEVICE=KBD (keyboard) if present, TTYA otherwise); check INPUT−DEVICE for any key pressed and set state variables in NVRAM accordingly perform basic diagnostics on caches and MMUs; initialize caches and MMUS; perform partial memory test; probe memory and clear top memory region; setup I/D MMUs with valid mapping; enable MMUs and instruction/data caches; copy CORE into memory and transfer control to the RAM copy; setup trap table in memory; initialize h/w interrupts; probe for type and size of Flash PROMs in the system; initialize TOD; calibrate CPU counter to determine module speed; setup alarm function services; initialize I2C controller, probe for system's Primary PCI bus; configure the on-board net device; probe for diskette drive; execute POST dropin; locate the client in PROM and if found, copy into memory and transfer control to it; enter user interface.

ASCII Command Line Interfaice

In one embodiment, the CORE user interface supports the following commands:

1) help—to get help on UI commands

2) malloc <size>—to allocate memory buffer

3) free <address>—to free allocated memory buffer

4) dump <addr><n>[asi]—to dump “n” bytes from a specified address

5) bcopy <src><dest><#bytes>—to copy a block of memory to another address

6) [safe-] peek <addr><1|2|4|8>[asi]—to load byte/short/word/long data from a specified address

The safe-peek command would not give any exception in case of any error. This would return Oxff.ff instead.

7) poke <addr><1|2|4|8><data>[asi]—to store byte/short/word/long data to a specified address

8) trap <trap#><par0-VAL>..<par5-VAL>

<trap#>is the service number

<par0-VAL>..<par5-VAL>upto six parameters—to generate a soft trap

9) set-nvram <var-name/ID><val>—to assign a value to an nvram variable

10) get-nvram <var-name/ID>—to get the current value of a variable

11) delete-nvram <ID>—to delete an NVRAM variable

12) print-nvram—to print NVRAM data

13) set-defaults—to set the NVRAM variables to default values

14) flash-update <dev><file>—to update the client/CORE in Flash PROM

15) load <dev><file><address>—to load a file into the memory

16) go <address>—Jump to the memory location where file is loaded

17) execute [client-name]—to execute the client as specified

18) reset—to Soft reset of the system

19) Input-device <tty|kbd>—to change the input device

An Exemplary Computer System

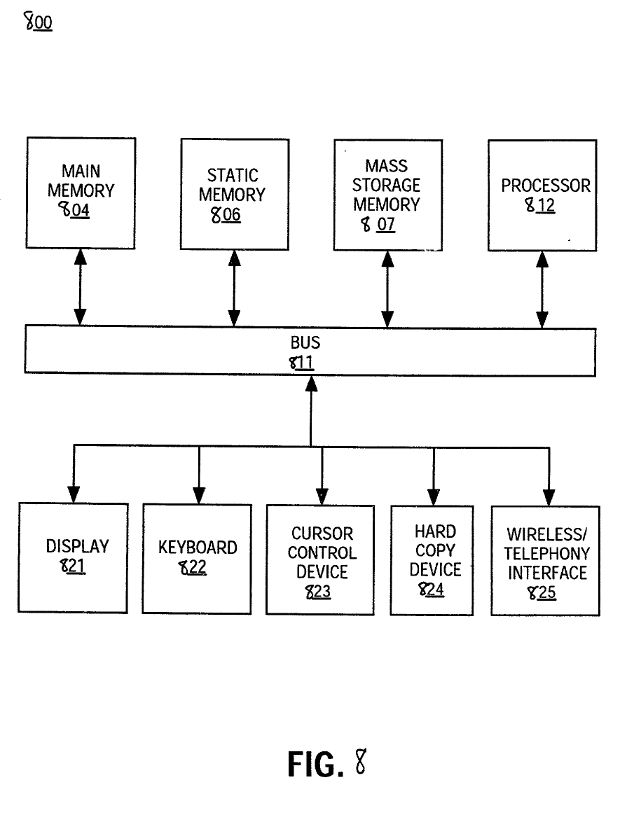

FIG. 8 is a block diagram of an exemplary computer system that may perform one or more of the operations described herein. Referring to FIG. 8, computer system 800 may comprise an exemplary client 850 or server 800 computer system. Computer system 800 comprises a communication mechanism or bus 811 for communicating information, and a processor 812 coupled with bus 811 for processing information. Processor 812 includes a microprocessor, but is not limited to a microprocessor, such as, for example, SPARC™.

System 800 further comprises a random access memory (RAM), or other dynamic storage device 804 (referred to as main memory) coupled to bus 811 for storing information and instructions to be executed by processor 812. Main memory 804 also may be used for storing temporary variables or other intermediate information during execution of instructions by processor 812.

Computer system 800 also comprises a read only memory (ROM) and/or other static storage device 806 coupled to bus 811 for storing static information and instructions for processor 812, and a data storage device 807, such as a magnetic disk or optical disk and its corresponding disk drive. Data storage device 807 is coupled to bus 811 for storing information and instructions.

Computer system 800 may further be coupled to a display device 821, such as a cathode ray tube (CRT) or liquid crystal display (LCD), coupled to bus 811 for displaying information to a computer user. An alphanumeric input device 822, including alphanumeric and other keys, may also be coupled to bus 811 for communicating information and command selections to processor 812. An additional user input device is cursor control 823, such as a mouse, trackball, trackpad, stylus, or cursor direction keys, coupled to bus 811 for communicating direction information and command selections to processor 812, and for controlling cursor movement on display 821.

Another device that may be coupled to bus 811 is hard copy device 824, which may be used for printing instructions, data, or other information on a medium such as paper, film, or similar types of media. Furthermore, a sound recording and playback device, such as a speaker and/or microphone may optionally be coupled to bus 811 for audio interfacing with computer system 800. Another device that may be coupled to bus 811 is a wired/wireless communication capability 825 to communication to a phone or handheld palm device.

Note that any or all of the components of system 800 and associated hardware may be used in the present invention. However, it can be appreciated that other configurations of the computer system may include some or all of the devices.

Various embodiments of the system firmware common operations and reset environment obtain one or more of the following goals: to unify the system initialization and I/O operations for a higher level client (e.g., OBP, VxWorks, Chorus etc.) and reduce porting effort for a new OS or application as a client of firmware CORE; to avoid any duplication of effort for the same type of functions among various clients; and to provide a unified interface to higher level software via a soft trap mechanism.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

I claim:

1. A system comprising:
one or more hardware resources;
a plurality of client programs stored in memory; and
an operations and reset environment shared by the plurality of clients, the operations and reset environment implementing hardware specific functions to make available the one or more hardware resources to the plurality of clients using a common programming interface.

2. The system defined in claim 1 wherein the operations and reset environment comprises firmware.

3. The system defined in claim 1 wherein the operations of the operations and reset environment are commonly used by all of the plurality of clients.

4. The system defined in claim 1 wherein the common programming interface comprises a soft trap mechanism.

5. The system defined in claim 1 wherein the operations and reset environment defines a set of trap services for use by the plurality of clients in communicating with hardware.

6. The system defined in claim 1 wherein the operations and reset environment comprises configuration and initialization code and a driver set.

7. The system defined in claim 1 wherein the plurality of clients comprises at least one operating system and at least one application program.

8. The system defined in claim 1 wherein the hardware specific functions include input/output (I/O) services to access I/O resources.

9. The system defined in claim 1 wherein the operations and reset environment performs error recovery and trap handling.

10. A method by which a plurality of clients gain access to a common set of hardware functions via a common programming interface using an operations and reset environment, the method performed by the operations and reset environment comprising:
receiving a request from one of the plurality of clients specifying a trap type and a buffer with one or more input parameters associated with a trap services;
locating the trap type in a trap table;
executing a routine specified in the trap table to perform a hardware function associated with the trap type; and
returning one or more output parameters in the buffer.

11. The method defined in claim 10 wherein the trap type corresponds to a hardware operation that is performed by more than two of the plurality of clients.

12. The method defined in claim 10 wherein the trap type corresponds to an operation to initialize hardware.

13. The method defined in claim 10 further comprising defining at least one trap service for use by the plurality of clients.

14. The method defined in claim 10 further comprising:
executing the operations and reset environment from a read-only memory;
copying a portion of the operations and reset environment into a random-access memory (RAM); and
transferring control of the operations and reset environment to the operations and reset environment stored in the RAM.

15. The method defined in claim 10 wherein the plurality of clients comprises at least one operating system and at least one application program.

16. An article of manufacture comprising one or more recordable medium having executable instructions stored thereon which, when executed by a system, cause the system to:
create an operations and reset environment that provides access, via a common programming interface, to a plurality of clients, through which the environment
receives a request from one of the plurality of clients specifying a trap type and a buffer with one or more input parameters associated with a trap services;
locates the trap type in a trap table;
executes a routine specified in the trap table to perform a hardware function associated with the trap type; and
returns one or more output parameters in the buffer.

17. The article of manufacture defined in claim 16 wherein the trap type corresponds to a hardware operation that is performed by more than two of the plurality of clients.

18. The article of manufacture defined in claim 16 wherein the trap type corresponds to an operation to initialize hardware.

19. The article of manufacture defined in claim 16 wherein the plurality of instructions include instructions to define at least one trap service for use by the plurality of clients.

20. The article of manufacture defined in claim 16 wherein the plurality of clients comprises at least one operating system and at least one application program.
